(19) United States
(12) Patent Application Publication
(10) Pub. No.: US 2020/0036274 A1
(43) Pub. Date: Jan. 30, 2020

(54) SWITCHED RELUCTANCE MOTOR AND VEHICLE

(71) Applicant: HONDA MOTOR CO., LTD., Tokyo (JP)

(72) Inventor: Hidetaka OZAWA, Wako-shi (JP)

(21) Appl. No.: 16/519,439

(22) Filed: Jul. 23, 2019

(30) Foreign Application Priority Data
Jul. 25, 2018 (JP) 2018-139585

(51) Int. Cl. H02K 37/06; H02K 7/00; H02K 1/14; H02K 1/24

(52) U.S. Cl. CPC H02K 37/06; H02K 7/006; B60K 7/00; H02K 1/246; H02K 2213/03; H02K 1/146

(57) ABSTRACT

A switched reluctance motor, of an outer rotor type, includes an inner stator having a plurality of salient poles, around which coils of five phases are wound in concentrated winding, and an outer rotor having a plurality of rotor yokes that are formed separately, each being magnetized to have two magnetic poles generated in the rotor yoke, and having a rotor body that is constructed of a non-magnetic conductive material for retaining the plurality of rotor yokes. The switched reluctance motor is configured to excite corresponding salient poles, by simultaneous use of coils of two phases among the coils of five phases.

### TECHNICAL FIELD

The present invention relates to a switched reluctance motor and a vehicle.

### BACKGROUND ART

In the patent literature 1 (PTL1) cited below, etc., it is described about a switched reluctance motor having a general toothed-gear shaped rotor with 6 poles, a general internal toothed gear shaped stator with 8 poles (4 pole pairs). Each tooth of the stator is wound with a coil, and four-phase alternating currents are supplied to the coils. Two poles among the rotor poles, which oppose to each other with an axis in between, are attracted simultaneously by two stator poles attributed to the coils which are in being energized. Per one rotation of the rotor, each coil is energized with a current in three periods. Since the number of these periods are equal to the number of torque generation, in the whole motor, torques are generated in “3 (periods) times 8 (poles)=24 (periods·poles)”.

### CITATION LIST

### Patent Literature

Patent Literature 1 (PTL1): WO2016/017337A1

### SUMMARY OF INVENTION

### Technical Problem

Now, in the configuration described in the above PTL1, the output torque per unit volume of a motor is small, and therefore it is difficult to realize a small size motor with high output power. Further, since the entire back yoke of the rotor forms a magnetic path, there is a problem that the eddy-current loss and the hysteresis loss become larger, leading to impairment of efficiency.

The present invention has been achieved considering the above matter, and aims at providing a switched reluctance motor with a large output power per unit volume and a high efficiency, and at providing a vehicle thereof.

### Solution to Problem

To solve the above problem, a switched reluctance motor of the present invention is a switched reluctance motor of an outer rotor type, comprising an inner stator having a plurality of salient poles, around which coils of five phases are wound in concentrated winding, and an outer rotor having a plurality of rotor yokes which are formed separately, each being magnetized to have two magnetic poles generated in the rotor yoke, and having a rotor body constructed of a non-magnetic conductive material for retaining the plurality of rotor yokes, wherein the switched reluctance motor is configured to excite corresponding salient poles, by simultaneous use of coils of two phases among the coils of five phases

### Advantageous Effect of the Invention

According to the present invention, it is possible to realize a switched reluctance motor with a high output power per unit volume and a high efficiency.

### BRIEF DESCRIPTION OF DRAWINGS

FIG. 1 shows a schematic diagram of a motor driving system according to an embodiment of the present invention.

FIG. 2 shows a waveform diagram of output currents from an inverter in an embodiment.

FIG. 3 shows a distribution of magnetic field lines in an embodiment.

FIG. 4 shows an enlarged view of a major part of FIG. 3.

FIG. 5 shows another distribution of magnetic field lines in an embodiment.

FIG. 6 shows another distribution of magnetic field lines in an embodiment.

FIG. 7 shows another distribution of magnetic field lines in an embodiment.

FIG. 8 shows another distribution of magnetic field lines in an embodiment.

FIG. 9 shows a schematic diagram of a motor driving system according to a comparison example.

FIG. 10 shows a waveform diagram of output currents from an inverter in a comparison example.

### DESCRIPTION OF EMBODIMENTS

### (Configuration of an Embodiment)

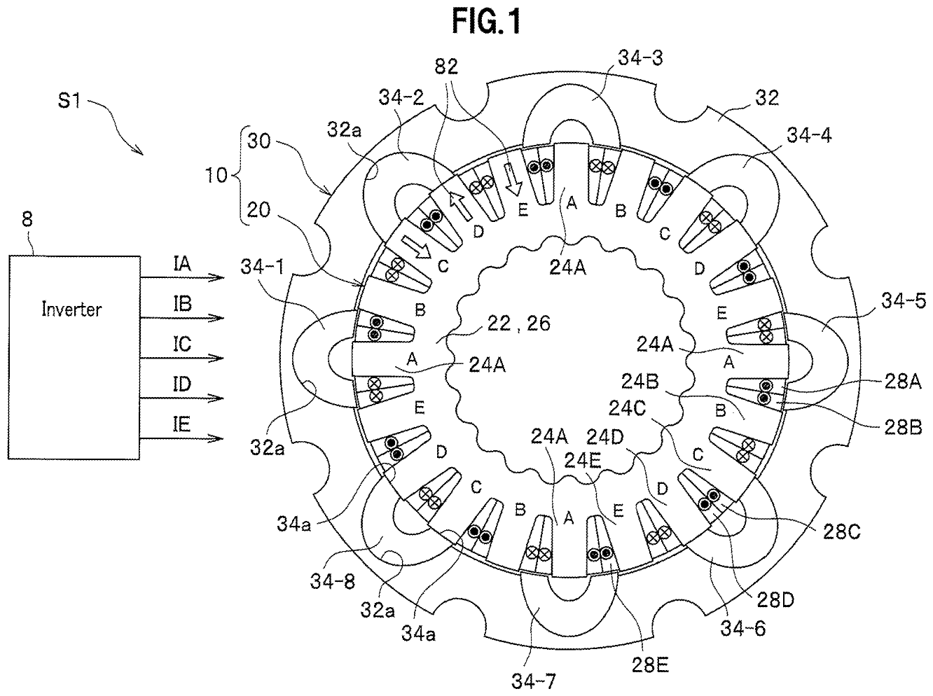

FIG. 1 shows a schematic diagram of a motor driving system 51 according to an embodiment of the present invention.

In FIG. 1, the motor driving system 51 comprises an inverter 8 and a switched reluctance motor 10 (hereinafter occasionally called as motor 10) driven by the inverter 8. The motor 10 is a five phases motor of an outer rotor type, and the inverter 8 supplies five phases currents IA, IB, IC, ID, IE of five phases A, B, C, D, E to the motor 10. In FIG. 1, the motor 10 is shown in its cross section. The motor 10 comprises a stator 20 (inner stator) formed in a general cylindrical shape, and a rotor 30 (outer rotor) arranged rotatably and concentrically in outer circumference side of the stator 20.

The stator 20 comprises, for example, a stator core 22 configured with laminated magnetic steel plates, and coils 28A, 28B, 28C, 28D, 28E (hereinafter occasionally called as “coil 28” collectively). Further, the stator core 22 comprises a stator yoke 26 formed in a general cylindrical shape, and a plurality of salient poles 24A, 24B, 24C, 24D, 24E (hereinafter occasionally called as “salient pole 24” collectively). The salient poles 24 are formed in a general cuboid shape and are provided to protrude from the circumferential surface of the stator yoke 26 in a radial direction. The stator yoke 26 and the salient poles 24 are formed integrally. The salient poles 24A, 24B, 24C, 24D, 24E are corresponding to the phases A, B, C, D, E, respectively, wherein 4 poles are provided for each phase.

Further, these salient poles 24 are arranged clockwise one after another in order of A-, B-, C-, D-, E-phases. It should be noted that, in FIG. 1, the reference signs, such as 24A, 24B, are only given partly, and for the rest simply the characters “A”, “B”, “C”, “D”, “E” are given. The number of the salient poles 24 is in total 5×4=20, wherein the salient poles 24 are formed at 20 positions which are equally distanced in circumferential direction of the stator 20. Thus the pitch angle of the salient poles 24 is 360°/20=18°.

The coils 28A, 28B, 28C, 28D, 28E are wound around their corresponding respective salient poles 24A, 24B, 24C, 24D, 24E in a concentrated winding. Then, to each coil 28, a current of a corresponding phase, IA, IB, IC, ID, IE, is supplied. Here, the direction of the current flowing in each coil 28 is as shown in FIG. 1. Namely, a mark x within a circle, which is given to each coil 28, represents a current flow in direction from frontside to backside of the figure, whereas a mark of black-filled double circle represents a current flow in direction from backside to frontside of the figure. Thus, also the direction of magnetic flux generated in each salient pole is determined in correspondence to the direction of a current. In a part of the figure, a direction of a generated magnetic flux is shown with an outline arrow.

The rotor 30 comprises a rotor body 32 and eight rotor yokes 34-1 to 34-8 (hereinafter occasionally called as “rotor yoke 34” or “magnetic path forming portion”, collectively). The rotor body 32 is formed in a general cylindrical shape, where in its inner circumference groove portions 32a of a general U-shape are formed at eight positions which are equally distanced in circumferential direction. Each rotor yoke 34 is constructed with a soft magnetic material of a general U-shape, where its outer circumferential surface has shape contouring along a groove portion 32a of the rotor body 32. Due to this, the rotor yoke 34 forms a magnetic path which is curved in a general U-shape. The rotor yokes 34 can be constructed, for example, with laminated magnetic steel plates. Each rotor yoke 34 are fit into the groove portion 32a, and thus fixed to the rotor body 32.

A pair of end faces 34a of each rotor yoke 34 form a pair of rotor magnetic poles. Thus, the rotor 30 is a rotor of “16 poles”. And, the pitch angle of a pair of end faces 34a of a rotor yoke 34 in the circumferential direction is approximately equal to the pitch angle of a salient pole 24 in the stator 20, namely “18°”. The rotor body 32 is formed with a material having a sufficiently lower magnetic permeability than the rotor yokes 34. For example, a non-magnetic conductor, such as an aluminum alloy or a magnesium alloy, can be applied to the rotor body 32. When “10 poles” of the stator 20 and “8 poles” of the rotor 30 (the number of rotor yokes 34 is 4) are regarded as “1 circuit”, then the motor shown in FIG. 1 is a motor of “2 circuits”.

### (Functioning of the Embodiment)

Next, the functioning of the embodiment will be explained.

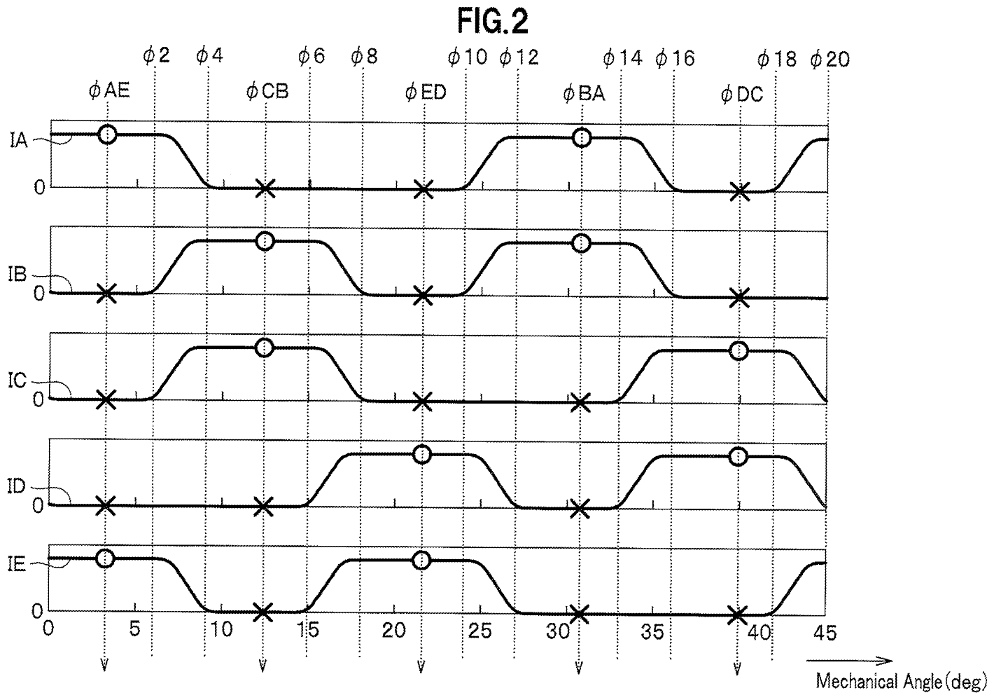

FIG. 2 is an example of waveforms of currents IA, IB, IC, ID, IE outputted from the inverter 8.

The horizontal axis of FIG. 2 represents the phase of mechanical angle of the rotor 30, showing the range 0°-45° in a case when the rotor 30 is rotated by a predetermined rotational speed. And, according to the construction of the motor 10 as shown in FIG. 1, a mechanical angle 45° corresponds to an electrical angle 360°. In the phase ϕAE shown in the figure, the currents IA, IE denoted with the marks (◯) are in the level of 100%, and the other currents IB, IC, ID denoted with the marks (x) are zero values. In the phase ranges thereafter ϕ2-ϕ4, when the phase ϕ proceeds, the currents IA, IE will decrease and the currents IB, IC will increase.

In the phase thereafter ϕCB, the currents IB, IC denoted with the marks (◯) are in the level of 100%, and the other currents IA, ID, IE denoted with the marks (x) are zero values. In the phase ranges thereafter ϕ6-ϕ8, when the phase ϕ proceeds, the currents IB, IC will decrease and the currents ID, IE will increase. In the phase thereafter ϕED, the currents ID, IE denoted with the marks (◯) are in the level of 100%, and the other currents IA, IB, IC denoted with the marks (x) are zero values. In the phase ranges thereafter ϕ10-ϕ12, when the phase ϕ proceeds, the currents ID, IE will decrease and the currents IA, IB will increase.

In the phase thereafter ϕBA, the currents IA, IB denoted with the marks (◯) are in the level of 100%, and the other currents IC, ID, IE denoted with the marks (x) are zero values. In the phase ranges thereafter ϕ14-ϕ16, when the phase ϕ proceeds, the currents IA, IB will decrease and the currents IC, ID will increase. In the phase thereafter ϕDC, the currents IC, ID denoted with the marks (◯) are in the level of 100%, and the other currents IA, IB, IE denoted with the marks (x) are zero values. In the phase ranges thereafter ϕ18-ϕ20, when the phase ϕ proceeds, the currents IC, ID will decrease and the currents IA, IE will increase. As explained above, FIG. 2 shows the waveforms of respective currents outputted from the inverter 8 for the range 0°-45° of phase ϕ, while in the range 45°-360°, the inverter 8 outputs respective currents repeatedly every 45° with a similar pattern.

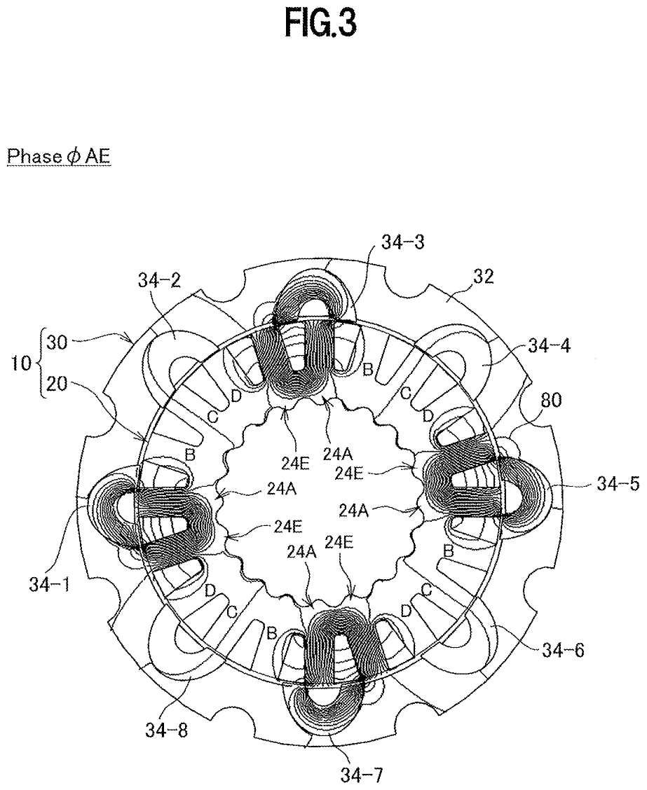

FIG. 3 shows a distribution of magnetic field lines 80 in the phase ϕAE.

In the phase ϕAE, a magnetic flux flows between the respective salient poles 24A, 24E and the rotor yokes 34-1, 34-3, 34-5, 34-7.

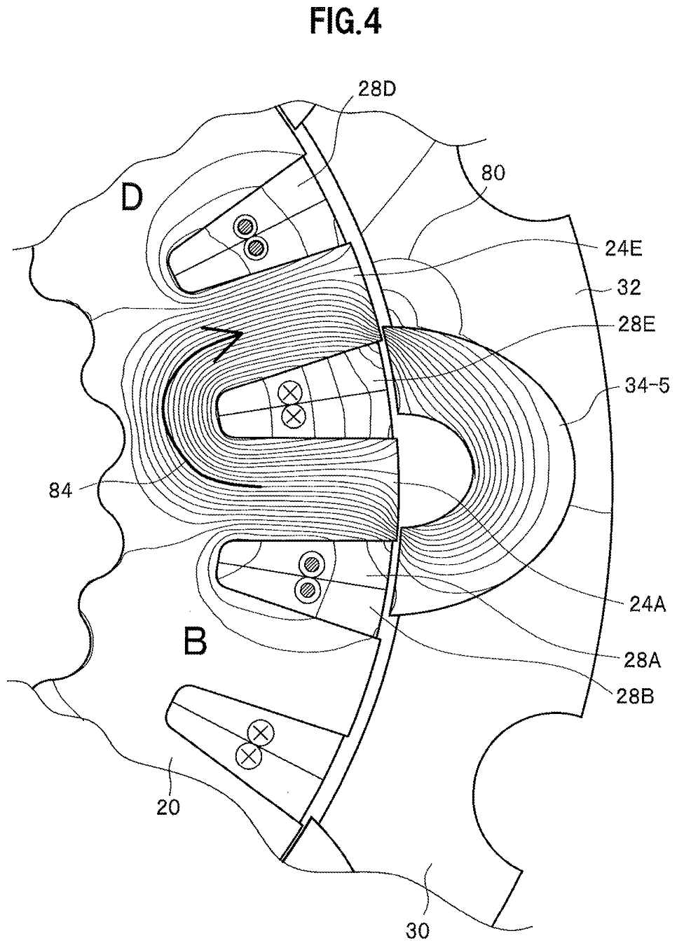

FIG. 4 shows an enlarged view of a portion around the rotor yoke 34-5 in FIG. 3.

As shown in the figure, the magnetic flux flows via the salient poles 24A, 24E and the rotor yoke 34-5 in the direction denoted with an arrow 84. Further at the locations where the rotor yoke 34-5 and the salient poles 24A, 24E are opposing to each other, the magnetic flux is squeezed. A torque is exerted to the stator 20 and the rotor 30 in a direction to resolve the squeeze. Therefore, the rotor 30 rotates to the anticlockwise direction.

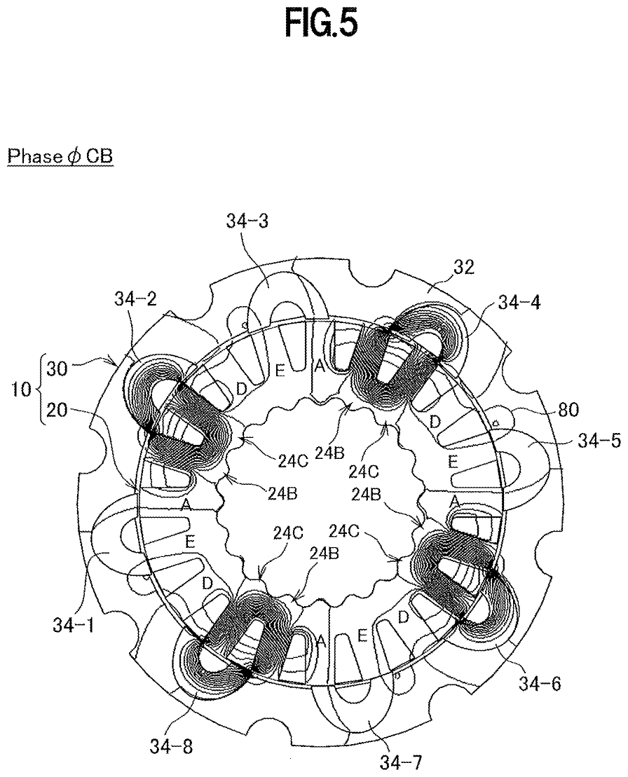

FIG. 5 shows a distribution of magnetic field lines 80 in the phase ϕCB.

In the phase ϕCB, the magnetic flux flows between the respective salient poles 24B, 24C and the rotor yokes 34-2, 34-4, 34-6, 34-8. In the state shown in the figure, again at the locations where the rotor yokes 34-2, 34-4, 34-6, 34-8 and the salient poles 24B, 24C are opposing to each other, the magnetic flux is squeezed. Again, a torque is exerted to the stator 20 and the rotor 30 in a direction to resolve the squeeze, and thus the rotor 30 rotates to the anticlockwise direction.

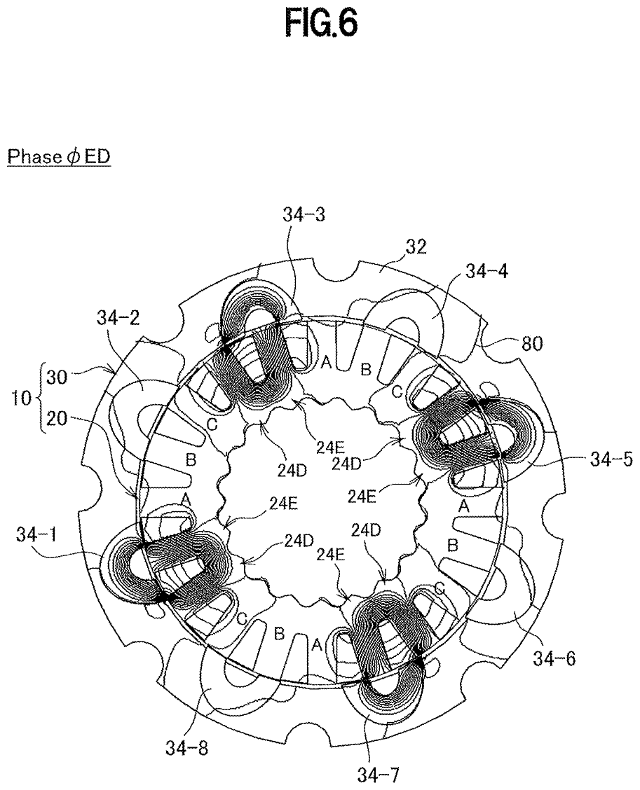

FIG. 6 shows a distribution of magnetic field lines 80 in the phase ϕED.

In the phase ϕED, the magnetic flux flows between the respective salient poles 24D, 24E and the rotor yokes 34-1, 34-3, 34-5, 34-7. In the state shown in the figure, again at the locations where these rotor yokes and the salient poles 24D, 24E are opposing to each other, the magnetic flux is squeezed. Again, a torque is exerted to the stator 20 and the rotor 30 in a direction to resolve the squeeze, and thus the rotor 30 rotates to the anticlockwise direction.

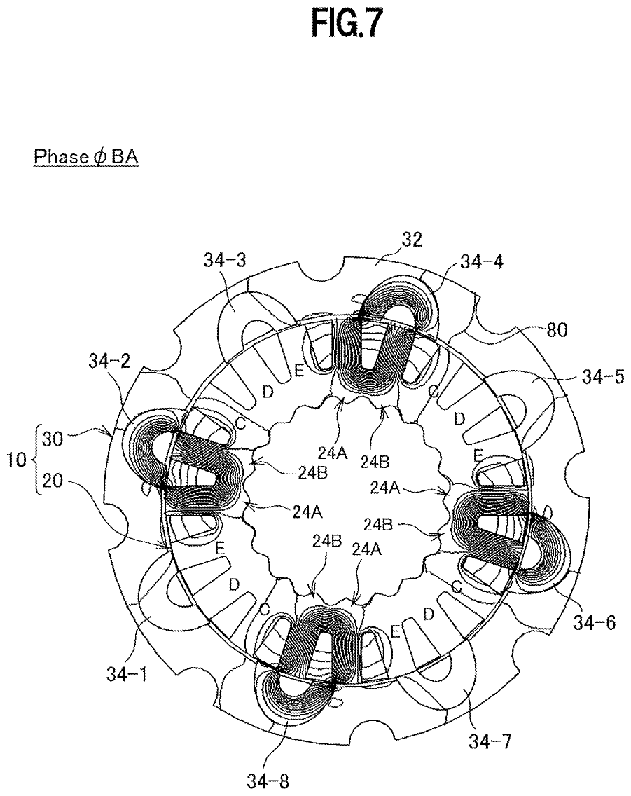

FIG. 7 shows a distribution of magnetic field lines 80 in the phase ϕBA.

In the phase ϕBA, the magnetic flux flows between the respective salient poles 24A, 24B and the rotor yokes 34-2, 34-4, 34-6, 34-8. In the state shown in the figure, again at the locations where these rotor yokes and the salient poles 24A, 24B are opposing to each other, the magnetic flux is squeezed. Again, a torque is exerted to the stator 20 and the rotor 30 in a direction to resolve the squeeze, and thus the rotor 30 rotates to the anticlockwise direction.

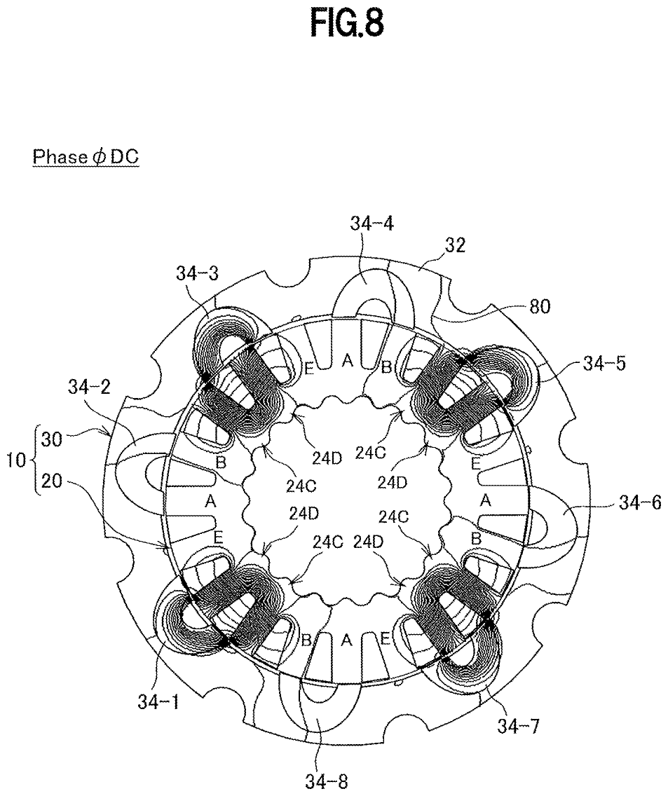

FIG. 8 shows a distribution of magnetic field lines 80 in the phase ϕDC.

In the phase ϕDC, the magnetic flux flows between the respective salient poles 24C, 24D and the rotor yokes 34-1, 34-3, 34-5, 34-7. In the state shown in the figure, again at the locations where these rotor yokes and the salient poles 24C, 24D are opposing to each other, the magnetic flux is squeezed. Again, a torque is exerted to the stator 20 and the rotor 30 in a direction to resolve the squeeze, and thus the rotor 30 rotates to the anticlockwise direction.

As described above, a pair of end faces 34a of each rotor yoke 34 (refer to FIG. 1) form a pair of rotor magnetic poles. Further, according to FIGS. 3 to 8, at the two rotor poles formed on a rotor yoke 34, the magnetic flux is flowing in opposite directions to each other. In the present embodiment, the magnetic fluxes flowing in respective rotor yokes 34 are independent to each other, and therefore the magnetic paths are formed locally. Due to this, it is possible to make the magnetic path lengths shorter, by which the eddy current loss and the hysteresis loss can be made to be very small.

The motor 10 in the present embodiment can be applied to a vehicle (not shown in the figure) comprising a vehicle body, a battery, wheels, etc., in which the wheels are driven by the battery. In particular, the motor 10 is applied preferably as in-wheel motors which are installed within the wheels. When a material such as an aluminum alloy or a magnesium alloy is applied, the rotor body 32 can also play a role of a structure member connecting the vehicle body and a wheel. Due to this, it is possible to realize a switched reluctance motor 10 of outer rotor type, which has a rotor body 32 with a low-cost and robust construction. Further, since the motor 10 of the present embodiment can be configured in relatively light weight for its high output power, it is possible to reduce an unsprung weight of the vehicle.

Further, in each state of the phases ϕAE, ϕCB, ϕED, ϕBA, ϕDC as shown in FIGS. 5 to 8, the magnetic field lines 80 are squeezed at eight locations in each case. Since a torque is generated at a location where the squeeze arises, in a period in which the rotor 30 is rotated by mechanical angle 45°, the torque generating events occur in total 40 times. Then, in a period, in which the rotor 30 is rotated by mechanical angle 360°, the torque generating events occur 320 times.

### COMPARISON EXAMPLE

Next, to make the effect of the present embodiment clear, it will be explained about a comparison example for the present embodiment.

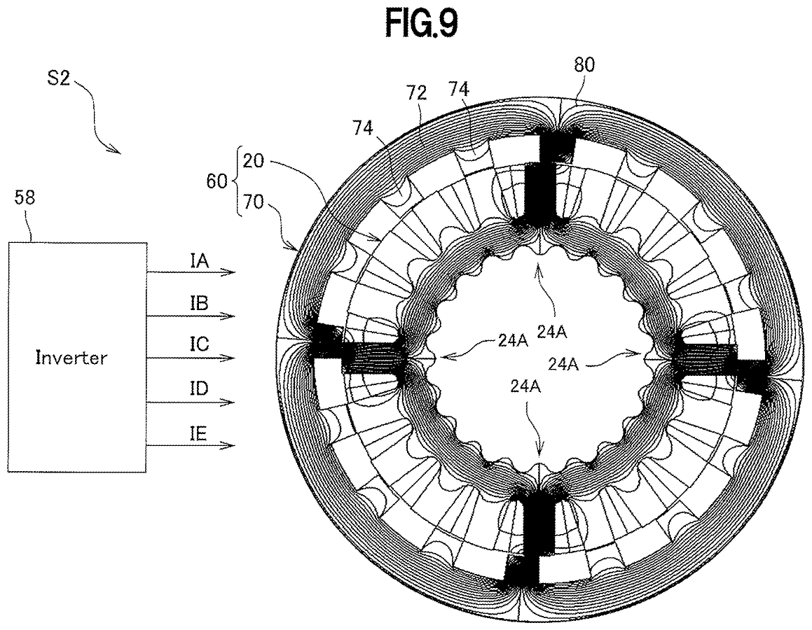

FIG. 9 shows a schematic diagram of a motor driving system S2 in a comparison example.

In FIG. 9, the motor driving system S2 comprises an inverter 58 and a switched reluctance motor 60 (hereinafter occasionally called as motor 60) which is driven by the inverter 58. The motor 60 is a five phases motor of an outer rotor type and comprises a stator 20 and a rotor 70 arranged rotatably and concentrically in outer circumference of the stator 20.

In FIG. 9, the configuration of the stator 20 is similar to that of the above embodiment (refer to FIG. 1).

And, the rotor 70 comprises a back yoke 72 and a plurality of salient poles 74. The back yoke 72 is formed in a general cylindrical shape. Further, the salient poles 74 are formed in a general cuboid shape and arranged at 16 positions which are equally distanced on the inner circumferential surface of the back yoke 72 in its inner circumferential direction, protruding in a direction to the center. Namely, the number of poles of the rotor 70 is “16”, and in this regard the back yoke 72 is similar to the rotor 30 of the above embodiment. These stator yoke 26 and salient poles 24 are integrally formed, for example by laminating electromagnetic steel plates. The inverter 58 supplies currents of five phases A, B, C, D, E as currents IA, IB, IC, ID, IE to the motor 10.

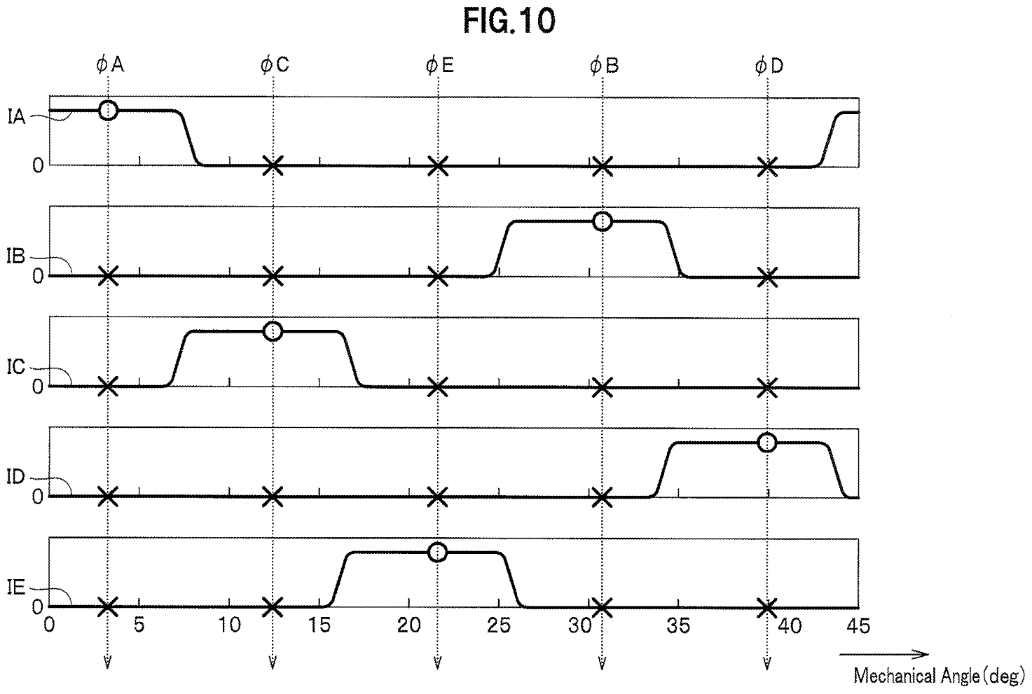

FIG. 10 shows an example of a waveform diagram of currents IA, IB, IC, ID, IE in the comparison example. Similarly to FIG. 2, the horizontal axis represents the phase of mechanical angle of the rotor 70, showing the range 0°-45° in a case when the rotor 70 is rotated by a predetermined rotational speed. Namely, also in the present example, a mechanical angle 45° corresponds to an electrical angle 360°. In the mechanical angles ϕA, ϕB, ϕC, ϕD, ϕE, the portions denoted respectively with the marks ◯ are in 100% levels, and the portions denoted respectively with the marks x are in zero values.

Returning to FIG. 9, the magnetic field lines 80 show a distribution of magnetic field lines in the mechanical angle ϕA, where the magnetic field lines 80 are squeezed at four positions around the salient poles 24A. Though, in the other phases ϕC, ϕE, ϕB, ϕD, the magnetic field lines are omitted in the figure, nevertheless a squeeze arises at four positions. Therefore, in the present example, in a period during which the rotor 70 rotates by amount of mechanical angle 45°, the torque generating events occur 4×5=20 times. Then, for the period during which the rotor 70 rotates by amount of mechanical angle 360°, the torque generating events occur 160 times. In this way, the number of torque generation events in the example becomes “½” of the above embodiment. Further, as shown in FIG. 9, in the example, the magnetic flux flows over the whole back yoke 72 of the rotor 70. Due to this, in the configuration of the present example, the magnetic path becomes longer than that of the embodiment described above, resulting in that an eddy current loss and a hysteresis loss become larger.

### Effect of the Embodiment

As describe above, the switched reluctance motor (10) of the present embodiment is a switched reluctance motor (10) of an outer rotor type, comprising an inner stator (20) having a plurality of salient poles (24), around which coils of five phases (28) are wound in concentrated winding, and an outer rotor (30) having a plurality of rotor yokes (34) which are formed separately, each being magnetized to have two magnetic poles generated in the rotor yoke, and having a rotor body (32) which retains the plurality of the rotor yokes (34) and is constructed with a non-magnetic conductive material, wherein the switched reluctance motor is configured to excite corresponding salient poles (24), by use of coils of two phases (28) among the coils of five phases (28).

Due to this, since it is possible to magnetically insulate the salient poles for respective phases, and since it is possible to largely reduce the magnetic interference with the other phases, an eddy current loss and a hysteresis loss can be largely reduced. In particular, in the present embodiment, since the salient poles of two phases among the five phases can be excited, a torque density per unit motor volume (Nm/m³) can be increased, as large as twice torque in comparison to the configuration of the example (FIGS. 9, 10).

Further, according to the present embodiment, the number of the salient poles (24) is “20”, and the number of the rotor yokes (34) is “8”, thus it is configured to excite corresponding “8” salient poles (24), by simultaneous use of coils of two phases (28) among the coils of five phases (28).

In a more general expression, as the number of salient poles comprised in the inner stator (20) is “20”, the number of rotor yokes (34) is “10N” (N: natural number), and the number of the rotor yokes (34) is “4N”, thus it is configured to excite corresponding “4N” salient poles, by simultaneous use of coils of two phases (28) among the coils of five phases (28).

In this case, when “N” is greater, the magnetic paths of the rotor yokes (34) can be further shortened.

Further, by installing a switched reluctance motor (10) of the present embodiment within a wheel of a vehicle as an in-wheel motor, it is possible to realize a vehicle with small unsprung weight.

### (Variation)

The present invention is not limited to the above described embodiment, but also enables further various variations. The above explained embodiment is for the purpose of easier understanding of the present invention, and therefore the present invention is not limited to those which have all configurations as explained above. Further, it is possible to add other configurations to the configurations of the above embodiment, and it is also possible to replace a part of the configurations of the above embodiment with other configurations. As possible variations to the above embodiment, the followings can be presented, for example.

(1) Though the switched reluctance motor 10 of the above embodiment is a motor of outer rotor type, the present invention can be applied to a switched reluctance motor of inner rotor type.
(2) Further, in order to form a general U-shaped curved magnetic path within the rotor 30, the rotor body 32 and the rotor yokes 34 are applied to the switched reluctance motor 10 of the above embodiment. However, the method for forming a general U-shaped curved magnetic path within the rotor 30 is not limited to this. For example, it is possible to configure the rotor 30 with a laminated electromagnetic steel plates, with which a general U-shaped curved magnetic path along a slit can be constructed by forming a slit in a general U-shape in each electromagnetic steel plate.

In the context of the above variations, the switched reluctance motor (10) of the above embodiment can be considered to be a switched reluctance motor comprising a stator (20) and a rotor (30) arranged concentrically to the stator (20), wherein the stator (20) has “10N” salient poles (N: natural number), being arranged in equal distances in circumferential direction, being wound with coils of five phases (29) in concentrated winding, and protruding to the rotor (30), and wherein the rotor (30) has “4N” magnetic path forming portions (34), each of which forming a curved magnetic path having two end faces (34a) arranged in a pitch corresponding to a pitch of the salient poles (24).

Further, the switched reluctance motor 10 can be applied to other apparatuses than a vehicle, such as ships, working machines, etc.

### REFERENCE SIGNS LIST

10 switched reluctance motor
20 stator (inner stator)
24, 24A, 24B, 24C, 24D, 24E salient pole
28, 28A, 28B, 28C, 28D, 28E coil
30 rotor (outer rotor)
32 rotor body
34, 34-1 to 34-8 rotor yoke (magnetic path forming portion)

1. A switched reluctance motor, of an outer rotor type, comprising:
an inner stator having a plurality of salient poles, around which coils of five phases are wound in concentrated winding, and
an outer rotor having a plurality of rotor yokes which are formed separately, each being magnetized to have two magnetic poles generated in the rotor yoke, and having a rotor body constructed of a non-magnetic conductive material for retaining the plurality of rotor yokes,
wherein
the switched reluctance motor is configured to excite corresponding salient poles, by simultaneous use of coils of two phases among the coils of five phases

2. The switched reluctance motor according to claim 1, wherein
number of the salient poles comprised in the inner stator is “20” and
number of the rotor yoke is “8”,
wherein
it is configured to excite corresponding “8” salient poles, by simultaneous use of coils of two phases among the coils of five phases.

3. The switched reluctance motor according to claim 1, wherein
number of the salient poles comprised in the inner stator is “10N” (N: natural number),
number of the rotor yokes is “4N”,
wherein
it is configured to excite corresponding “4N” salient poles, by simultaneous use of coils of two phases among the coils of five phases.

4. A switched reluctance motor, comprising:
a stator, and
a rotor arranged concentrically to the rotor,
wherein
the stator has “10N” salient poles (N: natural number), being arranged in equal distances in circumferential direction, being wound with coils of five phases in concentrated winding, and protruding to the rotor, and
wherein
the rotor has “4N” magnetic path forming portions, each of which forming a curved magnetic path having two end faces arranged in a pitch corresponding to a pitch of the salient poles.

5. A vehicle in which a switched reluctance motor according to claim 1 is installed within a wheel.
